(19) United States
(12) Patent Application Publication
(10) Pub. No.: US 2015/0376010 A1
(43) Pub. Date: Dec. 31, 2015

(54) PROCESS AND PRODUCTION PLANT FOR PREPARING NITRIC ACID

(71) Applicants: MESSER GROUP GMBH, Bad Soden (DE); Messer Austria GmbH, Gumpoldskirchen (AT)

(72) Inventors: Walter BACHLEITNER, Wels (AT); Thomas BERGER, Essen (DE); Joachim ROHOVEC, Baden Bei Wien (AT)

(21) Appl. No.: 14/766,078

(22) PCT Filed: Feb. 7, 2014
(86) PCT No.: PCT/EP2014/000333

§ 371 Date: Aug. 5, 2015

(30) Foreign Application Priority Data
Feb. 7, 2013 (DE) 10 2013 002 201.0

(51) Int. Cl. C01B 21/40; B01J 19/24

(52) U.S. Cl. CPC C01B 21/40; B01J 19/24; B01J 2219/00162; B01J 2219/24

(57) ABSTRACT

In a process for preparing nitric acid, nitrogen oxides are first generated in an ammonia combustion plant (2), and these are then supplied to at least one absorption tower (4, 5). In the absorption tower (4, 5), the nitrogen oxides are contacted in the water and oxygen, with at least partial reaction of the nitrogen-containing gas mixture with the water and the oxygen to form an aqueous nitric acid-containing solution which collects at the base of the absorption tower (4, 5) and is subsequently compressed and introduced via a riser line (12, 14, 21) back into the absorption tower (4, 5). In order to minimize the concentration of nitrogen oxides in the offgas from such a plant, it is proposed in accordance with the invention that oxygen be introduced in liquid form or gaseous form into a region of the riser line (12, 14, 21) that is lower in a geodetic sense. This promotes the dissolution of the oxygen and the reaction of the oxygen with likewise dissolved nitrogen oxides to give nitric acid.

The present invention relates to a process for preparing nitric acid according to the preamble of claim 1. The invention further relates to a production plant for preparing nitric acid.

For the industrial preparation of nitric acid, generally a four-stage catalytic ammonia oxidation process (Ostwald process) is used. In the first step, ammonia and oxygen are reacted in a reactor (hereinafter also called “ammonia combustion appliance”) in the presence of a mesh catalyst mostly comprising noble metals, for example platinum-rhodium, to form nitrogen monoxide and steam:

4NH₃+5O₂⇄4NO+6H₂O (1)

In order to promote the sought-after reaction over competing reactions, in the reactor the operating temperature is as high as possible, for example 900° C., which is only limited by the stability of the noble metal mesh and the threatened loss of noble metal associated therewith. Generally, a superstoichiometric amount of air or oxygen is employed in order to keep the flammability of the reaction mixture and the reactor exit temperature under control and to provide additional oxygen for subsequent oxidation reactions. Subsequently, the reactor discharge is cooled in a condenser to a temperature at which the water condenses. In this case some of the nitrogen monoxide reacts with water and oxygen to form an aqueous nitric acid-containing solution which furthermore also contains nitrogen oxides, in particular nitrogen monoxide, in dissolved form. The remaining gas mixture which does not pass into solution is fed to an absorption tower (hereinafter also called “absorption column”) in which some of the gaseous nitrogen monoxide is oxidized with oxygen, which is provided in the form of atmospheric oxygen or in the form of pure oxygen, to form nitrogen dioxide, or the dimer thereof, dinitrogen tetroxide, which are subsequently reacted with water to form nitric acid:

2NO+O₂⇄2NO₂ (2)

2NO₂⇄N₂O₄ (3)

NO₂+H₂O⇄HNO₃+NO (4)

2N₂O₄+O₂+2H₂O⇄4HNO₃ (5)

The water in this case usually passes through the absorption tower in counterflow to the ascending gas stream. The nitric acid collects at the bottom of the absorption tower in an aqueous solution. This nitric acid-containing solution is, just as is the nitric acid-containing solution already formed in the condenser, taken off, pumped to the top of the absorption tower and sprayed in there, in order to react the nitrous gases still present in the solution to form nitric acid. In many cases, a plurality of absorption towers are also connected sequentially, wherein the gas stream, or the nitric acid that is taken off, passes through the series of absorption towers in counterflow. In order to increase the absorption capacity for the nitrous gases, the gases in the absorption tower, or in the absorption towers, are brought to a higher pressure from 1 to 15 bar (g). In plants which have absorption columns operating at a comparatively low pressure from 1 to 5 bar (g) (low- and medium-pressure plants), the fraction of nitrous offgases in the offgas is very high, which is due, in particular, to a low oxygen partial pressure in the air which is usually used as oxygen-containing gas in the absorption column. Although applying higher pressures leads to a reduction of the residual content of nitrogen oxides in the offgas, it is associated with considerably increased costs for the compression and the design of the plant components correspondingly suitable for higher pressures.

In order to increase the efficiency of the process, therefore, attempts have already been made to increase the oxygen partial pressure by introducing additional oxygen at various sites, and thereby to reduce the fraction of nitrous gases in the offgas.

For instance, EP 0 799 794 A1 proposes supplying oxygen, or an oxygen-enriched gas, to the above-outlined process for nitric acid production downstream of the ammonia combustion appliance, but upstream of the absorption column.

According to the teaching of U.S. Pat. No. 5,266,291 B1 and U.S. Pat. No. 5,360,603 B1 oxygen-enriched air is introduced into the ammonia oxidation reactor. The available excess oxygen permits an increase in the ammonia supply and therefore an increase in the existing capacity; however, the temperature of the system and the flammability must, at the same time, be kept under control by introducing water or inert gases into the inlet part of the reactor.

EP 1 013 604 B1 proposes to inject additional oxygen into the nitric acid-containing process stream in order to form a gas bubble/liquid mixture therein which has a fine dispersion of gas bubbles having diameters of less than about 0.1 mm. As a result, a large surface area between the gas and the liquid mixture is achieved, as a result of which contaminants in the nitric acid that is formed are said to be minimized and the requirement for oxygen additionally fed in the system is said to be reduced.

U.S. Pat. No. 4,235,858 B1 discloses a process for nitric acid production in which cold oxygen (T<0° C.) is passed into the absorption tower. The introduction proceeds in this case into the gas chamber of the absorption tower. The low temperature of the oxygen is said to promote the generation of nitrogen dioxide or dinitrogen tetroxide from nitrogen monoxide in accordance with (2) and (3) and thereby increase in total the nitric acid production.

Despite such improvements, it is possible to achieve a further increase in capacity and process optimization of the process described at the outset for nitric acid production, which is likewise an object of the present invention.

This object is achieved by a process having the features of claim 1 and also by a production plant for preparing nitric acid having the features of claim 7. Advantageous embodiments of the invention are specified in the subclaims.

The process according to the invention for preparing nitric acid is therefore characterized in that oxygen is introduced into the aqueous nitric acid-containing solution which arises in the condensation of the reaction products of the ammonia combustion in the condenser and/or in the absorption of the gases containing nitrogen oxides in the absorption tower (or the absorption towers) and are fed via riser pipes to an upper region, in particular the head space, of the absorption tower (or the head spaces of the absorption towers). The invention proceeds from the basic concept that nitrogen oxides (substantially nitrogen monoxide) are also present in dissolved form in the nitric acid-containing solution. By introducing oxygen, these nitrogen oxides react with oxygen and water:

H₂O+2NO+1½O₂⇄2HNO₃ (6)

This reaction proceeds substantially in the direction of the formation of nitric acid, the back reaction is negligible. Since a higher pressure promotes the gaseous starting materials of the reaction, the nitric acid-containing solution is “compressed” before the introduction of the oxygen, that is to say brought to a pressure which is higher than the operating pressure in the absorption tower. In the simplest case, the oxygen for this purpose is fed into the system at a point at which in any case a particularly high pressure prevails. For this purpose, in particular, the geodetically lower sections of the riser pipes are suitable, since on account of the hydrostatic pressure during the transport of the nitric acid-containing solution to the head space of an absorption tower, a pressure elevated in comparison with the operating pressure of the absorption tower already prevails. Preferably, therefore, the oxygen is introduced in each case at a point of the riser pipe which is situated at the height or beneath the height of the bottom of that absorption tower into the upper region of which the riser pipe discharges. The invention however, also comprises those embodiments in which a high pressure is generated in the riser pipe or in a bypass pipe branching off therefrom, in particular a pressure which is higher than that corresponding to the hydrostatic pressure of the nitric acid-containing solution in the riser pipe. Also conceivable in the context of the invention, furthermore, is a batchwise treatment of the nitric acid-containing solution with oxygen under correspondingly high pressures in pressure vessels. In the context of the invention, it is not excluded, furthermore, that in supplementation to the introduction of oxygen into the nitric acid-containing solution, additional oxygen is introduced elsewhere, for example directly into the absorption tower.

It proves to be particularly advantageous when the nitric acid-containing solution, before the feed of the oxygen, is compressed to a pressure which is higher, for example by at least 1 to 2 bar, than the operating pressure of the absorption column into which the nitric acid-containing solution is introduced. This is advantageous, in particular, for low- and medium-pressure columns which have an operating pressure of only 1 to 5 bar (g). Preferably, the nitric acid-containing solution is brought in these cases to a pressure of preferably at least 4.5 bar (g) before the feed of the oxygen. By additional measures for pressure boosting, such as, for example, appropriately designed transport appliances, an additionally advantageous compression can be achieved, for example to a value between 5 and 15 bar (g).

As “oxygen”, preferably oxygen having a purity of at least 95% by volume is used, but the oxygen can also be fed in the form of air or as another oxygen-containing gas mixture. The oxygen is fed to the nitric acid-containing solution in gaseous form, or else in cryogenically liquefied form, wherein, at least in the latter case, care must be taken to ensure that the flow paths do not ice up owing to the feed of the cryogenic medium. Alternatively, liquid oxygen can be vaporized before it is fed to the nitric acid-containing solution. This can proceed in a customary air evaporator, or the cold content of the liquid oxygen is utilized in other ways, for example for the abovementioned cooling of the reaction products of the ammonia combustion.

An advantageous development of the invention provides that, the oxygen, or the oxygen-containing gas, is fed at a temperature below ambient temperature, preferably below 0° C. The invention, in this embodiment proceeds from the knowledge that the exothermic reaction steps proceeding in the riser pipe and subsequently in the absorption tower proceed the more rapidly, the lower the temperature is. By feeding the cold or cryogenic oxygen, the temperature of the reactive mixture is lowered and the reaction rate is hereby accelerated. The cold oxygen required according to the invention is stored, for example, in a well thermally insulated tank facility and/or can be withdrawn directly from the oxygen product stream of an air separation plant. Since in the latter case the oxygen of such a plant already arises in cryogenic liquid form, in this case, complex apparatuses for cooling the oxygen are dispensed with. To this extent, it is particularly advantageous to combine in apparatus terms an appliance for nitric acid production with a cryogenic air separation plant.

An embodiment of the invention which is again preferred provides that, in a bypass pipe assigned to the corresponding riser pipe, a substream is branched off from the nitric acid-containing solution, which substream is compressed and enriched with oxygen and then fed to the main stream of the nitric acid-containing solution before it is fed to the head space of the absorption tower. In this embodiment, it is therefore sufficient to compress only the substream, into which the oxygen is then introduced, to a higher pressure of, for example, 5 to 15 bar.

A production plant according to the invention for preparing nitric acid, comprises an ammonia combustion plant for reacting ammonia with oxygen to form nitrogen oxides and steam, a condenser that is connected to the ammonia combustion plant for cooling the reaction products of the ammonia combustion plant to a temperature below the condensation temperature of water, at least one absorption tower arranged downstream of the condenser for scrubbing the gas mixture formed in the condenser with water, at least one transport appliance-equipped riser pipe for feeding a nitric acid-containing solution from the condenser or from the bottom region of the absorption tower or of the absorption towers, which opens out into an upper (in comparison with the bottom region) region of the absorption tower or the absorption towers, and also an oxygen feed pipe that is connectable to a source of oxygen which discharges into the riser pipe, downstream of the transport appliance, at an introduction appliance in a geodetically lower region. As introduction appliance, for example an introduction lance or a Venturi nozzle comes into consideration. It is essential to the invention that the introduction system is suitable for mixing the introduced oxygen and the nitric acid-containing solution rapidly and intimately with one another and to promote the formation of nitric acid in the riser pipe on account of an increased pressure in the reaction region. The introduction appliance is therefore arranged in a lower region—seen geodetically—of the riser pipe; particularly preferably, the introduction system is situated at the height of, or beneath the height of, the bottom of the absorption tower into the upper region (e.g. the head space) of which the nitric acid-containing solution is applied. This embodiment has two advantages in particular: firstly, the hydrostatic pressure of the liquid column present in the riser pipe is utilized to provide a pressure which is increased in comparison with the operating pressure in the absorption tower, which promotes the generation of nitric acid in the riser tube. Secondly, the entire following section of the riser pipe between introduction system and head space is used as reactor for carrying out the abovementioned reaction (6) for generating nitric acid. Therefore, it is particularly advantageous, if means for increasing the contact time are provided, for example an enlarged flow cross section of this section of the riser pipe, on account of which the flow velocity of the liquid conducted therethrough is reduced, or an elongation of the riser pipe in which the reactants come into contact with one another.

In an advantageous variant of the invention, the riser pipe comprises a bypass pipe into which the oxygen feed pipe discharges. This embodiment is therefore characterized in that a substream is branched off from the nitric acid-containing solution, which substream is compressed to the desired pressure, enriched with oxygen and then again fed to the main stream of the nitric acid-containing solution before feed thereof to the head space of the absorption tower. The bypass pipe is also expediently situated in a geodetically lower section of the riser pipe.

In an embodiment of the invention which is again advantageous, in the riser pipe and/or the bypass pipe, there is provided an appliance for pressure boosting, by means of which the pressure in the riser pipe or in the bypass pipe is adjustable to a value which is higher than the hydrostatic pressure necessary for transporting the nitric acid-containing solution to the top of the absorption tower. The pressure which is boosted in this manner for example of 10-15 bar (g) promotes the dissolution of the oxygen and the formation of nitric acid in the riser pipe.

Preferably, the introduction appliance is equipped with a pressure value, by means of which a minimum value for the overpressure of the oxygen that is fed relative to the pressure in the riser pipe can be set. Such a pressure valve comprises, for example, a shutoff element which is only adjustable to the opening position thereof against the action of a return spring. By the choice or setting of the spring force of the return spring, a minimum overpressure of, for example, 0.1 to 10 bar can readily be set, which the oxygen is to have on feed thereof.

A preferred embodiment of the invention provides that the introduction appliance is equipped with an end section which opens out substantially in the cross sectional center of the riser tube, and that in the region upstream of the mouth opening of the injection appliance, there is provided a mixing section for the intimate mixing of oxygen and nitric acid-containing solution. This embodiment avoids, via the design of the introduction appliance, the oxygen that is fed coming directly into contact with the wall of the riser pipe. In this manner, severe corrosion on the riser pipe owing to the oxygen introduced is avoided. The mixing section comprises in this case the remaining section of the riser pipe downstream of the introduction appliance; preferably, this is therefore constructed to be as long as possible, or it has an expanded opening cross section which slows the flow rate of the nitric acid-containing solution in this region.

A further advantageous embodiment of the invention provides that the introduction appliances and/or the sections of the riser pipe that are arranged downstream of the introduction appliance and/or the bypass pipe into which the oxygen is fed are equipped with a catalyst in order to promote the reaction of the nitrogen oxides that are present in the nitric acid-containing solution with the oxygen that is introduced. For example, within a riser pipe or a bypass pipe, a packing with Raschig rings or other packing materials can be provided which have suitable catalytic packing materials that can accelerate the oxidation reactions. As catalysts, for example metal catalysts come into consideration, which can exhibit strong O₂ chemisorption and therefore are usable in principle, such as, for example, metal catalysts which contain one metal or a plurality of metals selected from the following group: Ti, Zr, Hf, V, Nb, Ta, Cr, Mo, W, Fe, Ru, Os, Ni, Co, Rh, Pd, Pt, Ir, Mn, Cu; Al, Au; Li, Na, K, Mg, Ag, Zn, Cd, In, Si, Ge, Sn, Pb, As, Sb, Bi.

In this case, particularly preferably, these catalysts can be applied in finely divided form on sintered ceramic hollow bodies. For instance, sintered SiO₂, Al₂O₃ or aluminosilicates, for example NaAlSiO₃ or KAlSiO₃, for example, are frequently used in the catalyst industry and can also be used here after any necessary adaptation.

The catalyst packings used can also be used in the abovementioned bypass pipes and thus lead to faster reactions and improved yields.

With reference to the drawings, an exemplary embodiment of the invention will be described in more detail. In the drawings, in diagrammatic views:

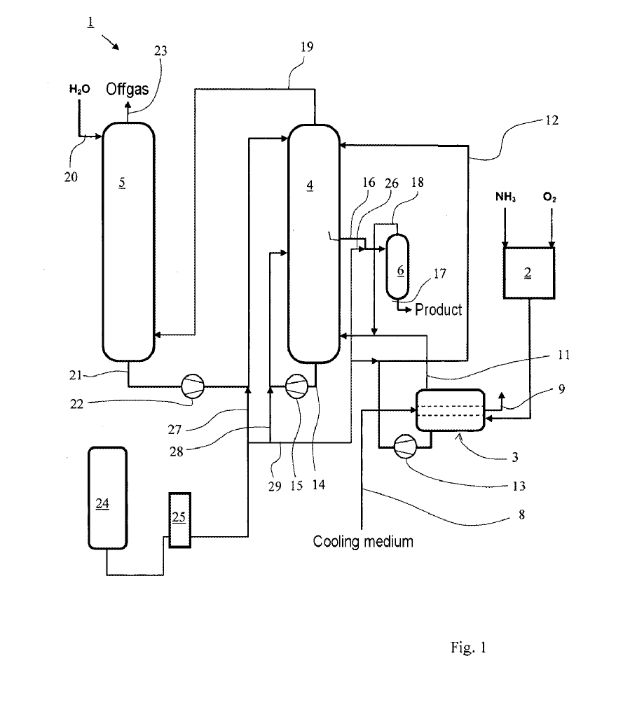

FIG. 1: shows the circuit diagram of a production plant according to the invention for preparing nitric acid,

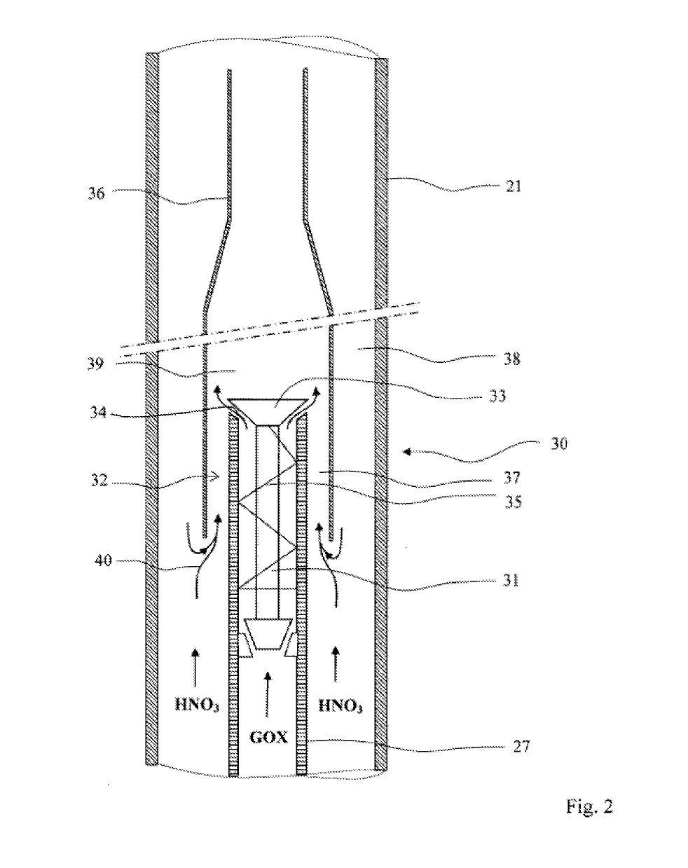

FIG. 2: shows an appliance for introducing oxygen into a nitric acid-conducting riser pipe in longitudinal section.

FIG. 1 shows a production plant 1 for preparing nitric acid. In a manner known per se, the production plant 1 comprises an ammonia combustion plant 2, a condenser 3, a plurality of, in the exemplary embodiment two, absorption towers 4, 5, and a bleaching column 6. The absorption towers 4, 5, in the exemplary embodiment, are low- and medium-pressure columns which operate at an operating pressure from 2 to 5 bar (g); however, medium-pressure or high-pressure columns having an operating pressure of up to 15 bar (g) can also be used.

The ammonia combustion plant 2 serves for reacting gaseous ammonia and oxygen at a temperature between 600° C. and 900° C. in the presence of a mesh catalyst made of a noble metal, such as platinum for example, or an alloy of platinum/rhodium, to form nitrogen monoxide and steam. As oxygen, usually atmospheric oxygen is used in this case, but pure oxygen having an oxygen content of >95% by volume or another oxygen-containing gas can also be used. The reaction products of the reaction proceeding in the ammonia combustion plant 2, substantially nitrogen monoxide and steam, and also excess oxygen, are fed to the condenser 3, in which the reaction products are cooled by thermal contact with a cooling medium introduced via a cooling medium feed pipe 8, for example water or liquefied or cold gaseous nitrogen, to a temperature at which the steam condenses, for example to 60° C. to 80° C. The cooling medium that is heated in the heat exchange is removed via a cooling medium outlet pipe 9 and let off to atmosphere or fed to another use. A part of the nitrogen monoxide oxidizes with excess oxygen to form nitrogen dioxide or the dimer thereof dinitrogen tetraoxide. Some of the nitrogen oxides react with the water to form nitric acid which separates out at the bottom of the condenser 3 in an aqueous solution. The gas mixture present in the condenser 3 is introduced via a gas feed pipe 11 into a lower region of the absorption tower 4. The aqueous nitric acid-containing solution from the bottom of the condenser 3 is fed via a riser pipe 12 to the head space of the absorption tower 4, wherein a transport appliance 13 ensures the necessary pressure for overcoming the hydrostatic pressure in the riser pipe 12. Since absorption towers frequently have structural heights of 30 m and more, the hydrostatic pressure in the geodetically lower region of the riser pipe 12 is considerable and is, for example, 4.5-5 bar (g).

The aqueous nitric acid-containing solution from the condenser 3 is sprayed into the head space of the absorption tower 4 by means of a nozzle arrangement 15 which is not described in more detail here, falls downwards and in the course of this comes into contact with the nitrogen oxide-containing gases that are ascending from the bottom. In this case, further fractions of the nitrogen oxides present in the gas mixture react with water and the oxygen present in the gas mixture to form nitric acid, which collects in an aqueous solution in the bottom region of the absorption tower 4. This aqueous nitric acid-containing solution is taken off via a riser pipe 14, transported by means of a transport appliance 15 to a middle region of the absorption tower 4 and sprayed in there.

Water from a water feed pipe 20 is sprayed into the head space of the absorption tower 5. The nitrogen oxide-containing gas mixture ascending from the bottom comes into contact in the absorption tower 5 with the water that is sprayed in and reacts at least in part therewith and oxygen present in the gas mixture to form nitric acid, which collects at the bottom of the absorption tower 5 in an aqueous solution. This aqueous nitric acid-containing solution is taken off via a riser pipe 21 and conducted by means of a transport appliance 22 to the top of the absorption column 4 and sprayed in there.

In the middle region of the absorption tower 4, nitric acid-containing solution is taken off and fed via an outlet pipe 16 to the bleaching column 6, bleached and removed via a product outlet pipe 17. In the bleaching column, in turn, nitrogen oxide-containing gas arises which is introduced via a pipe 18 into the gas pipe 11 and via this into the absorption tower 4.

The nitrogen oxide-containing gas mixture remaining in the absorption tower 4 is removed via a gas outlet pipe 19 and introduced into a lower region of the absorption tower 5. Gas mixture still present in the absorption tower 5 is passed out via an offgas pipe 23 and fed to an appliance which is not shown here for denitration, in which the remaining nitrogen oxides are very largely removed from the gas mixture. For reasons of clarity, the exemplary embodiment shown in FIG. 1 comprises only two absorption columns 4, 5; of course, in the context of the invention, exemplary embodiments having three or more absorption towers are also conceivable through which the nitrogen oxide-containing gas streams and the aqueous nitric acid-containing solutions flow in counterflow in a known manner.

In order to increase the oxygen partial pressure in the absorption columns 4, 5 and thereby improve the absorption of the nitrous gases, oxygen is fed to the absorption columns 4, 5. The oxygen is withdrawn from a source of oxygen which, in the exemplary embodiment, is a tank 24 for liquid oxygen; however, it can alternatively be, for example, a pressure vessel for gaseous oxygen, a pipe line or an appliance for air separation. The liquid oxygen from the tank 24 passes through an air evaporator 25 in a manner known per se and is fed cold, but in gaseous form, via oxygen feed pipes 26, 27, 28, 29 to the riser pipes 12, 14, 21 and also the outlet pipe 16. Moreover, instead of the gasification in an air evaporator 25, the cold content of the liquefied oxygen, can also be made use of for cooling the reaction products of the ammonia combustion plant 2 in the condenser 3, by, for example, subjecting the cooling medium used there to a heat exchange with the liquid oxygen from the tank 24, or the liquid oxygen from tank 24 is fed directly to the condenser 3 as cooling medium.

Some of the oxygen from the tank 24 is passed via the oxygen feed pipe 26 into the outlet pipe 16 and together with the still contaminated nitric acid conducted through the outlet line 16, introduced into the bleaching column (bleaching column) 6. There, it supports the bleaching, in particular by removing any nitrogen oxides still dissolved in the nitric acid. In the head space of the bleaching column 6, an oxygen-rich gas phase collects, which is taken off via pipe 18 and combined with the gas mixture from the condenser 3 conducted via the pipe 11.

The oxygen is introduced in a geodetically lower region of the respective riser pipe 12, 14, 21 and downstream of the respective transport appliance 13, 15, 22 in order to utilize the hydrostatic pressure of the liquid column present in the riser pipe 12, 14, 21 and any additional pressure generated by the respective transport appliance 13, 15, 22. Within the section of the riser pipe 12, 14, 21 following downstream of the entry point for the oxygen, the oxygen partly dissolves and a reaction of nitrogen oxides which are dissolved in the nitric acid-containing solution with water and the oxygen that is introduced, forming nitric acid takes place. Some of the excess oxygen introduced does not react with the nitrogen oxides and passes in the gaseous state into the respective absorption tower 4, 5 where it leads to a higher oxygen partial pressure which in turn prompts the formation of nitric acid in the respective absorption tower 4, 5. The formation of nitric acid is in addition supported by the low temperature of the oxygen that is fed.

In FIG. 2, by way of example, an injection appliance 30 is shown for feeding oxygen from the oxygen pipe 27 into the nitric acid-containing solution in riser pipe 21. The oxygen feed pipe 27 discharges in a geodetically lower region of the riser pipe 21, about at the height of, or beneath, the bottom of the absorption tower 4, and downstream of the transport appliance 22. The injection appliance 30, which at the same time forms the end section of the oxygen pipe 27, is arranged coaxially within a vertically ascending section of the riser pipe 21, wherein between the outer surface of the injection appliance 30 and the inner surface of the riser pipe 21, an annular channel remains. The injection appliance 30 comprises a pressure value 32 having a blocking element 31 which has a disk-shaped front section 33 which, on the rear side thereof facing the oxygen feed pipe 27, is shaped in a truncated cone manner and thereby adapted in the shape thereof to the discharge mouth 34 which is cut in likewise in the shape of a truncated cone of the oxygen feed pipe 27. The pressure value 32 is constructed in such a manner that the blocking element 31 can only be opened against the force of a return spring 35. This is the case when, on account of the pressure in the oxygen feed pipe 27, the force acting on the blocking element 31 exceeds the sum of the return force of the return spring 35 and the force acting on the pressure valve 32 on account of the pressure acting in the riser pipe 21. This ensures that the oxygen is introduced with overpressure with respect to the pressure prevailing in the riser pipe 21. On account of the choice of a return spring 35 having a corresponding return force, in the case of the embodiment according to FIG. 2, a minimum overpressure can be readily set in this manner which the oxygen is to have on feed thereof. Coaxially to the injection appliance 30 there is arranged a flow funnel 36 which is separated from the injection appliance 32 by an inner annular channel 37 and from the riser pipe 21 by an outer annular channel 38 and extends to a region 39 downstream of the discharge mouth 34 of the oxygen feed pipe 27. The flow funnel 36 prevents, firstly, the oxygen which is introduced at the injection appliance 32 not coming immediately into contact with the inner wall of the riser pipe 21, as a result of which corrosion caused otherwise thereby is avoided, secondly it contributes in the manner described hereinafter to an intimate mixture of the introduced oxygen with the nitric acid-containing solution proceeding in the riser pipe 21.

In the operating state, nitric acid-containing solution flows through the riser pipe 21 from bottom to top—as indicated in FIG. 2 by arrows. At the same time, oxygen is conducted at high pressure through the oxygen pipe 28, forces the blocking element 31 against the force of the return spring 35 into its open state and flows at high velocity into the region 39 upstream of the mouth opening of the injection appliance 30. As a result, in the inner annular channel 37, a reduced pressure is caused, on account of which nitric acid-containing solution is increasingly conducted through the inner annular channel 37, wherein—as indicated by arrows 40—in addition nitric acid-containing solution is drawn in by suction from the outer annular channel 38 into the inner annular channel 37. In the region 39, on account of the higher open pipe cross section, there is a higher pressure, and intimate mixing of oxygen and nitric acid-containing solution occurs. Nitrogen oxides (predominantly NO) present in the solution react with oxygen and water to form nitric acid. In this manner, the concentration of the nitric acid increases on passing through the riser pipe 21 up to reaching the absorption tower 4. In order to increase the contact time of the reaction partners and to dissolve the oxygen as completely as possible, the section of the riser pipe 21 following downstream of the flow funnel 36 can be equipped with an expanded cross section, in order in this region to retard the flow velocity of the nitric acid-containing solution. Injection systems such as the injection appliance 30 sketched here in the riser pipe 21 can, furthermore, be provided at all riser pipes 12, 14, 21 and the outlet pipe 16, in which nitric acid-containing solution is transported into the head space of an absorption tower 4, 5. An injection system such as the injection appliance 30 sketched here, can, furthermore, also be arranged in a bypass pipe (which is not shown here) branching off upstream of a riser pipe 12, 14, 21. Instead of, or in supplementation to, the injection appliance 30, other introduction systems for oxygen can also be provided, however, for example a bubbling device, by means of which oxygen can be introduced in the form of small gas bubbles into the pressurized nitric acid-containing solution.

In addition, a catalyst, for example a metal catalyst, can be provided to one of the riser pipes 12, 14, 21, downstream of the injection appliance, by means of which catalyst the oxidation of the nitrogen oxides present in the nitric acid-containing solution is promoted. Such a catalyst can be provided, for example, on a Raschid ring (which is not shown here) in the flow path of the nitric acid-containing solution.

The invention is also suitable, in particular, for retrofitting old plants which usually operate with absorption columns, the operating pressure of which is in the low- and medium-pressure range, that is to say at about 1 to 5 bar (g). However, the present invention is likewise usable for retrofitting high- and dual-pressure plants. In this case, even still more markedly lower NOₓ concentrations in the offgas could be achieved, as a result of which the operating costs of denitration plants could be markedly reduced, or the use thereof could even be avoided altogether. In this case, significant cost savings can result by saving of ammonia and/or natural gas, which are usually used as reducing agents for the denitration.

### LIST OF REFERENCE SYMBOLS

1. Production plant
2. Ammonia combustion plant
3. Condenser
4. Absorption tower
5. Absorption tower
6. Bleaching column
7. -
8. Cooling medium feed pipe
9. Cooling medium outlet pipe
10. -
11. Gas feed pipe
12. Riser pipe
13. Transport appliance
14. Riser pipe
15. Transport appliance
16. Outlet pipe
17. Product outlet pipe
18. Pipe
19. Gas outlet pipe
20. Water feed pipe
21. Riser pipe
22. Transport appliance
23. Offgas pipe
24. Tank
25. Air evaporator
26. Oxygen pipe
27. Oxygen pipe
28. Oxygen pipe
29. Oxygen pipe
30. Injection appliance
31. Blocking element
32. Valve
33. Front section
34. Discharge mouth
35. Return spring
36. Flow funnel
37. Inner annular channel
38. Outer annular channel
39. Region
40. Arrow

1. A process for preparing nitric acid, in which
a. in an ammonia combustion plant, ammonia is reacted with oxygen to form nitrogen oxides and steam,
b. the nitrogen oxides and the steam from step are cooled in a condenser to a temperature at which the steam condenses, wherein the nitrogen oxides in part react with the condensed steam and oxygen to form a nitric acid-containing solution and in part remain in a nitrogen oxide-containing gas mixture,
c. the nitrogen oxide-containing gas mixture of step is fed to an absorption tower in which it is brought into contact with water and oxygen, wherein the nitrogen oxide-containing gas mixture is reacted with the water and the oxygen at least in part with formation of an aqueous nitric acid-containing solution which collects at the bottom of the absorption tower,
d. the nitric acid-containing solution of step and/or the nitric acid-containing solution of step is taken off from the bottom of the absorption tower or from the condenser, compressed by means of a transport appliance and then fed via a riser pipe to an upper region of the absorption tower,
wherein
e. the nitric acid-containing solution of step and/or step is compressed and oxygen is introduced into the nitric acid-containing riser pipe/s downstream of the transport appliance.

2. The process as claimed in claim 1, wherein the oxygen is introduced into a geodetically lower region of the riser pipe/s conducting the nitric acid-containing solution of step and/or step downstream of the transport appliance.

3. The process as claimed in claim 1, wherein the nitric acid-containing solution is brought to a pressure of at least 4.5 bar before the feed of the oxygen.

4. The process according to claim 1, wherein the oxygen that is introduced into the riser pipe/s is fed in the liquefied or gaseous state.

5. The process according to claim 1, wherein the oxygen that is introduced into the riser pipe/s is fed at a temperature below ambient temperature, preferably below 0° C.

6. The process as claimed in claim 1, wherein a substream is branched off from the nitric acid-containing solution, which substream is compressed and enriched with oxygen and then fed to the main stream of the nitric acid-containing solution before it is fed to the head space of the absorption tower.

7. A production plant for preparing nitric acid, having an ammonia combustion plant for reacting ammonia with oxygen to form nitrogen oxides and steam, having a condenser that is connected to the ammonia combustion plant for cooling the reaction products of the ammonia combustion plant to a temperature below the condensation temperature of water,
having at least one absorption tower arranged downstream of the condenser for scrubbing the gas mixture formed in the condenser with water,
having at least one riser pipe for feeding a nitric acid-containing solution from the condenser or from the bottom region of the absorption tower or of the absorption towers, which riser pipe is equipped with a transport appliance and which opens out into an upper region of the absorption tower orone of the absorption towers, wherein
at least one oxygen feed pipe that is connectable to a source of oxygen is provided which discharges into the riser pipe downstream of the transport appliance at an introduction appliance that is arranged in a geodetically lower region of the riser pipe.

8. The production plant as claimed in claim 7, wherein the riser pipe comprises a bypass pipe into which the oxygen feed pipe discharges.

9. The production plant as claimed in claim 7, wherein, in the riser pipe, there is provided an appliance for pressure boosting, by means of which the pressure in the riser pipe or in the bypass pipe is adjustable to a value which is higher than the hydrostatic pressure necessary for transporting the nitric acid-containing solution to the top of the absorption tower.

10. The production plant as claimed in claims 7, wherein the introduction appliance is equipped with a pressure valve for setting a minimum overpressure of the oxygen in the oxygen feed pipe relative to the pressure in the riser pipe.

11. The production plant as claimed in claims 7, wherein the introduction appliance equipped with an end section which opens out substantially in the cross sectional center of the riser pipe, and in the region upstream of the mouth opening of the introduction appliance, there is provided a mixing section for the intimate mixing of oxygen and nitric acid-containing solution.

12. The production plant as claimed in claims 7, wherein the introduction appliance and/or the sections of the riser pipe that are arranged downstream of the introduction appliance or in the bypass pipe into which the oxygen feed pipe discharges are equipped with a catalyst for promoting the reaction of the nitrogen oxides that are present in the nitric acid-containing solution with the oxygen that is introduced.

13. The production plant as claimed in claim 12, wherein the catalyst is present in the form of a medium that is applied in finely divided form on a sintered ceramic hollow body.

14. The production plant as claimed in claim 12, wherein the catalyst is present in a bulk packing in the riser pipe or in the bypass pipe into which the oxygen feed pipe discharges.
